(19) United States
(12) Patent Application Publication
(10) Pub. No.: US 2025/0349143 A1
(43) Pub. Date: Nov. 13, 2025

(54) METHOD AND APPARATUS FOR TRAINING CHARACTER RECOGNITION MODEL, COMPUTER DEVICE, AND STORAGE MEDIUM

(71) Applicant: Jabil Inc., St. Petersburg, FL (US)

(72) Inventors: Jiaxin Deng, Chengdu City (CN); Tusson Du, Chengdu (CN); Vivian Sun, Sarasota, FL (US); May Yap, Singapore (SG)

(73) Assignee: Jabil Inc., St. Petersburg, FL (US)

(21) Appl. No.: 19/089,175

(22) Filed: Mar. 25, 2025

(30) Foreign Application Priority Data
May 7, 2024 (CN) 202410554317.3

(51) Int. Cl. G06V 30/19; G06V 10/77; G06V 10/82

(52) U.S. Cl. CPC G06V 30/19127; G06V 10/7715; G06V 10/82

(57) ABSTRACT

Described is a method and apparatus for training a character recognition model, a computer device, and a storage medium. The method includes: acquiring an input image and a labeled string of the input image; performing character recognition on the input image via the character recognition model pre-deployed on an edge device to obtain a predicted string of the input image; and performing a parameter update on a classification head in the character recognition model via a state space model in a case where the predicted string is inconsistent with the labeled string; wherein the state space model contains a state equation and an observation equation, the state equation is used to indicate an evolutionary relationship of a classification head parameter between different time steps, and the observation equation is used to generate an observable observation character based on the classification head parameter.

### TECHNICAL FIELD

The present application relates to the technical field of training of character recognition models, in particular to a method and apparatus for training a character recognition model, a computer device, and a storage medium.

### BACKGROUND

An optical character recognition (OCR) technology, as an important means of automatically recognizing text information in images, has been widely applied to many fields, such as intelligent document management, automatic driving, and mobile payment. A traditional OCR system mainly relies on predefined template matching or a statistical learning method for character recognition. Although real-time requirements can be met to a certain extent, its accuracy and efficiency are reduced in complex scenarios, and it is unable to cope with complex environmental changes, such as illumination, angle, position, and scale. As deep learning is widely applied to the field of image recognition, a deep OCR technology is an application of a deep learning technology to the field of text recognition, which can achieve high-precision character recognition, especially in complex scenarios, such as distortion, blurring, and font change.

In recent years, edge computing, as a complement and extension of cloud computing, aims to push some data processing, storage, and application services from a center node to an edge of a network, thereby reducing delay, saving bandwidth, protecting user privacy, and enhancing system stability. Although some lightweight deep OCR models have been designed and applied to edge devices, most of such models are unable to achieve real-time online learning in the edge devices, i.e., they are unable to dynamically update and optimize model parameters according to new input data.

### SUMMARY

Embodiments of the present application provide a method and apparatus for training a character recognition model, a computer device, and a storage medium. Learning and training of the deep OCR model may be performed in real time in an edge device, simplifying a model training process, reducing a learning cost, and improving model training efficiency. A technical solution is as follows.

On the one hand, a method for training a character recognition model is provided, performed by an edge device, and includes:
acquiring an input image and a labeled string of the input image;
performing character recognition on the input image via the character recognition model pre-deployed on the edge device to obtain a predicted string of the input image; and
performing a parameter update on a classification head in the character recognition model via a state space model in a case where the predicted string is inconsistent with the labeled string;
wherein the state space model contains a state equation and an observation equation, the state equation is used to indicate an evolutionary relationship of a classification head parameter between different time steps, and the observation equation is used to generate an observable observation character based on the classification head parameter.

On another hand, an apparatus for training a character recognition model is provided, applied in an edge device, and includes:
an acquisition module, configured to acquire an input image and a labeled string of the input image;
a character recognition module, configured to perform character recognition on the input image via the character recognition model pre-deployed on the edge device to obtain a predicted string of the input image; and
a parameter update module, configured to perform a parameter update on a classification head in the character recognition model via a state space model in a case where the predicted string is inconsistent with the labeled string; wherein the state space model contains a state equation and an observation equation, the state equation is used to indicate an evolutionary relationship of a classification head parameter between different time steps, and the observation equation is used to generate an observable observation character based on the classification head parameter.

In a possible implementation, the parameter update module includes:
a labeled character acquisition sub-module, configured to acquire a labeled character corresponding to each feature sequence block in a feature sequence of the input image; wherein the feature sequence of the input image is obtained by performing a feature extraction on the input image via an image feature extraction layer in the character recognition model; and
a parameter update sub-module, configured to traverse the feature sequence, and perform, based on each feature sequence block and the labeled character corresponding to each feature sequence block, the parameter update on the classification head in the character recognition model via the state space model.

In a possible implementation, the parameter update sub-module is configured to
predict a classification head parameter at a (k+1)-th time step based on a classification head parameter at a k-th time step corresponding to a target feature sequence block as well as the state equation to obtain a predicted classification head parameter at the (k+1)-th time step, wherein the target feature sequence block is any feature sequence block in the feature sequence, and k is a positive integer;
perform a matrix update on an error covariance matrix at the k-th time step based on a matrix update rule to obtain an error covariance matrix at the (k+1)-th time step; and
perform a parameter update on the classification head parameters and the error covariance matrices based on an observation character corresponding to the target feature sequence block, a labeled character corresponding to the target feature sequence block, the predicted classification head parameter at the (k+1)-th time step, and a Kalman gain, wherein the observation character corresponding to the target feature sequence block is obtained by a calculation of the observation equation based on the target feature sequence block as well as the classification head parameter at the k-th time step; and the Kalman gain is obtained by a calculation based on the error covariance matrix at the k-th time step and the error covariance matrix at the (k+1)-th time step.

In a possible implementation, the labeled character acquisition sub-module includes:
a matrix acquisition unit, configured to acquire a logits probability matrix corresponding to the feature sequence; wherein the logits probability matrix is obtained by performing feature classification on the feature sequence via the classification head of the character recognition model, and the logits probability matrix contains a probability distribution of converting each feature sequence block in the feature sequence into a character;
a matrix calculation unit, configured to calculate a cost matrix based on the labeled string and the logits probability matrix, wherein the cost matrix is used to indicate a cost of assigning each character in the labeled string to each image feature in the feature sequence;
a path determination unit, configured to traverse assignment paths based on the cost matrix, and determine a target assignment path, wherein the target assignment path is an assignment path with a minimum overall cost; and
a labeled character determination unit, configured to determine the labeled character corresponding to each feature sequence block in the feature sequence of the input image based on a path vector corresponding to the target assignment path, wherein the path vector is used to indicate a feature sequence block assigned to each character in the labeled string.

In a possible implementation, the labeled character determination unit is configured to determine labeled characters corresponding to a part of feature sequence blocks in the feature sequence of the input image based on the path vector; and
set labeled characters corresponding to another part of the feature sequence blocks in the feature sequence of the input image as null characters.

In a possible implementation, the apparatus further includes:
a match module, configured to determine that the predicted string is inconsistent with the labeled string when the feature sequence of the input image contains a target feature sequence block set; wherein a predicted character of each feature sequence block in the target feature sequence block set is inconsistent with a corresponding labeled character.

In a possible implementation, the parameter update module is configured to perform, based on the target feature sequence block set, the parameter update on the classification head in the character recognition model via the state space model.

On another hand, a computer device is provided, containing a processor and a memory. The memory stores at least one computer program. The at least one computer program is loaded and executed by the processor to implement the above method for training the character recognition model.

On another hand, a computer-readable storage medium is provided, storing at least one computer program therein. The computer program is loaded and executed by a processor to implement the above method for training the character recognition model.

On another hand, a computer program product is provided, including at least one computer program. The computer program is loaded and executed by a processor to implement the method for training the character recognition model provided in the various optional implementations above.

The technical solution provided by the present application may include the following beneficial effects.

According to the method for training the character recognition model provided by the embodiments of the present application, the edge device, after receiving the input image and the labeled string of the input image, calls the character recognition model pre-deployed on the edge device to perform the character recognition on the input image to obtain the corresponding predicted string. The parameter update is performed on the classification head in the character recognition model via the state space model in the case where the predicted string is inconsistent with the labeled string. The state equation in the state space model is used to indicate an evolutionary relationship of the classification head parameter between different time steps. The observation equation is used to generate the observable observation character based on the classification head parameter. Via the above method, an amount of data that the edge device needs to process during model training may be reduced, and learning and training of the deep OCR model are performed in real time in the edge device, simplifying a model training process, reducing a learning cost, and improving model training efficiency.

### BRIEF DESCRIPTION OF DRAWING(S)

Accompanying drawings here are incorporated into the specification, constitute a part of the specification, show embodiments consistent with the present application, and are used to explain a principle of the present application together with the specification.

FIG. 1 shows a flowchart of training a character recognition model provided by an exemplary embodiment of the present application.

FIG. 2 shows a schematic diagram of a process of training a character recognition model based on a deep OCR technology provided by an exemplary embodiment of the present application.

FIG. 3 shows a flowchart of training a character recognition model provided by an exemplary embodiment of the present application.

FIG. 4 shows a schematic structural diagram of a character recognition model provided by an exemplary embodiment of the present application.

FIG. 5 shows a calculation flow of a cost matrix algorithm provided by an exemplary embodiment of the present application.

FIG. 6 shows a calculation flow of a character assignment algorithm provided by an exemplary embodiment of the present application.

FIG. 7 shows a block flowchart of a method for training a character recognition model provided by an exemplary embodiment of the present application.

FIG. 8 shows a block diagram of an apparatus for training a character recognition model provided by an exemplary embodiment of the present application.

FIG. 9 shows a structural block diagram of a computer device showed by an exemplary embodiment of the present application.

FIG. 10 shows a structural block diagram of a computer device showed by an exemplary embodiment of the present application.

### DETAILED DESCRIPTION

Exemplary embodiments will be illustrated in detail here, and their examples are shown in accompanying drawings. When the following description refers to the accompanying drawings, unless otherwise indicated, the same numbers in different accompanying drawings indicate the same or similar elements. Implementations described in the following exemplary embodiments do not represent all implementations consistent with the present application. Rather, they are merely instances of apparatuses and methods consistent with some aspects of the present application as detailed in the appended claims.

It should be understood that “a number of” mentioned here refers to one or more, and “a plurality of” refers to two or more. “And/or” describes the association relationship of associated objects, which means that there can be three kinds of relationships, for example, A and/or B can mean that there are three kinds of situations: A alone, A and B at the same time, and B alone. A character “/” universally indicates that front and back associated objects are in an “or” relationship.

First, nouns involved in the present application are explained.

### 1) OCR (Optical Character Recognition)

Optical character recognition is a technology that captures a text image on a medium such as a paper document and a screen display utilizing an electronic device such as a scanner or a camera, and converts it into an editable text format via an image processing technology and a mode recognition algorithm. An OCR system converts text in the image into a computer-processable digital text format by recognizing a shape, arrangement, font features and other information of characters in the image, which is widely applied to various scenarios such as document digitization, certificate recognition, license plate recognition, book electronization, and form data extraction.

### 2) Deep OCR

Deep OCR is an upgraded method for recognizing a character that incorporates a deep learning technology based on traditional OCR. Usually a deep OCR model mainly contains two parts, one is a feature extraction module, and the other is a classification head. The feature extraction module learns and extracts high-level abstract features from the character image utilizing a deep neural network model, such as a convolutional neural network (CNN) and other sequence modeling technologies such as a recurrent neural network (RNN) or a long short-term memory (LSTM), to achieve high-precision character recognition in a more complex scenario, including, but not limited to, distortion deformation, blurring, font changes and other cases. The classification head is usually a linear head that maps extracted features to a probability distribution of a character set.

### 3) Deep Neural Network

The deep neural network is a multilayer nonlinear model built by imitating a working principle of neurons in a human brain, which is configured to process complex computing tasks, such as image recognition and semantic segmentation. The deep neural network obtained after being trained with a large amount of data may be used as a feature extraction layer.

Center nodes and edge devices are usually contained in a cloud computing environment. The center nodes usually refer to core infrastructures such as a service cluster, a large-scale storage system, and a high-performance computing platform in a cloud data center. They constitute a main body of a cloud service, are responsible for processing, storing, and managing a large quantity of data and applications, and provide various cloud computing services (e.g., IaaS, PaaS, and SaaS) for a user. The edge devices corresponding to the center nodes refer to devices that are located at an edge of a network, have certain computing and storage capabilities, and are responsible for data preprocessing, real-time response, service deployment and other functions. They and the center nodes complement each other and jointly build a distributed service system for cloud computing. An embodiment of the present application provides a method for training a character recognition model, which may achieve a real-time online update of the character recognition model in an edge device.

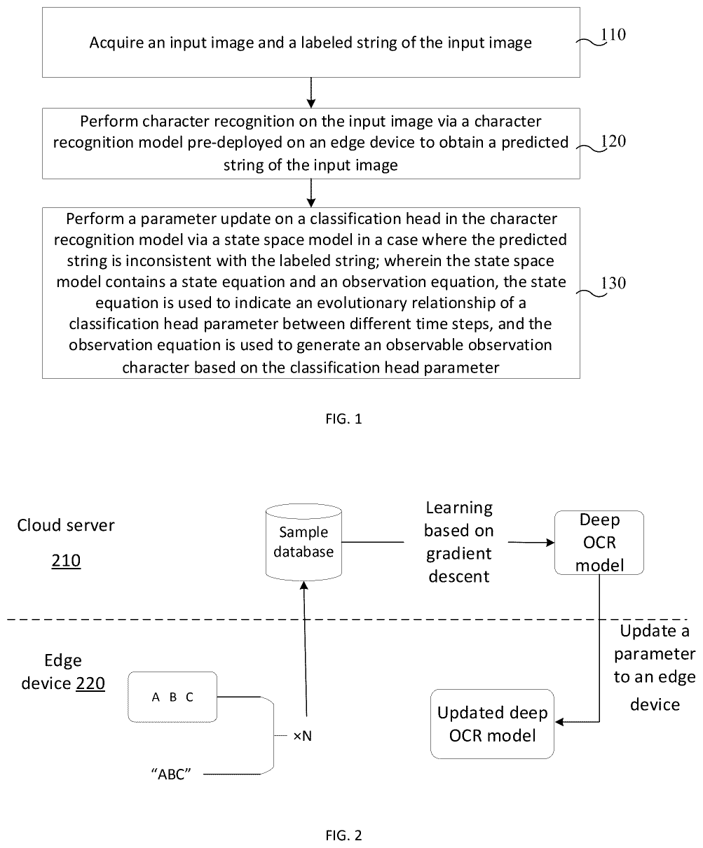

FIG. 1 shows a flowchart of training a character recognition model provided by an exemplary embodiment of the present application. The method may be performed by an edge device. The edge device may be implemented as a server or a terminal. As shown in FIG. 1, the method for training the character recognition model may include the following steps.

Step 110, an input image and a labeled string of the input image are acquired.

The input image is a to-be-learned image received by the edge device. The labeled string of the input image contains all character information in the input image.

Step 120, character recognition is performed on the input image via the character recognition model pre-deployed on the edge device to obtain a predicted string of the input image.

The character recognition model pre-deployed on the edge device may be obtained by training based on a traditional method for training a character recognition model. The character recognition model may be a deep OCR model. In a possible implementation, the character recognition model may be obtained by training based on a deep OCR technology. FIG. 2 shows a schematic diagram of a process of training a character recognition model based on a deep OCR technology provided by an exemplary embodiment of the present application. As shown in FIG. 2, a process of training and updating the character recognition model is performed in a cloud server 210. After the training and updating are completed, the cloud server 210 deploys the trained or updated character recognition model to an edge device 220. In the process, after a labeling person labels a string contained in an input image, the edge device 220 needs to transmit data back to the cloud server 210. The cloud server 210, after collecting sufficient sample data, performs a gradient descent-based process of training the model to obtain a deep OCR model. The trained deep OCR model is then deployed to the edge device 220, i.e., model parameters of the trained deep OCR model are updated into the deep OCR model deployed at an edge end. The cloud server 210 may collect sample data from a plurality of edge devices 220.

The edge device, after receiving the input image, inputs the input image into the pre-deployed character recognition model to obtain a predicted string corresponding to the input image.

Step 130, a parameter update is performed on a classification head in the character recognition model via a state space model in a case where the predicted string is inconsistent with the labeled string. The state space model contains a state equation and an observation equation. The state equation is used to indicate an evolutionary relationship of a classification head parameter between different time steps. The observation equation is used to generate an observable observation character based on the classification head parameter.

The state space model (SSM) is a type of modeling used to describe an intrinsic behavior of a dynamic system and an external observable phenomenon, and is usually composed of the state equation and the observation equation. The state equation describes how an internal state variable of the system evolves over time. The state variable represents an intrinsic state of the system at a certain moment. The observation equation represents how the state of the system is represented via observation data. The observation data are indirect and noisy reflections of the state of the system and may be observed directly or obtained through measurements.

Schematically, this state equation may be expressed as:

$${x}_{k + 1} = {A}_{k} {x}_{k} + {B}_{k} {u}_{k}$$

where xₖ is a state vector of the system, representing a state of the system at a moment k; uₖ is a control input of the system; and Aₖ and Bₖ are state transfer matrices, describing how the state vector evolves over time.

The observation equation may be expressed as:

$${y}_{k} = {H}_{k} {x}_{k} + {v}_{k}$$

where yₖ is an output of the system observed at the moment k; Hₖ is an observation matrix, describing a relationship between the state vector and an observation; and vₖ is a noise during an observation process.

In the embodiment of the present application, the character recognition model includes an image feature extraction layer, a classification head, and a decoder. The classification head is configured to classify image features extracted by the image feature extraction layer to obtain a probability distribution of converting the individual image features into text characters. The decoder is configured to output a corresponding predicted string by decoding based on the above probability distribution. Therefore, the classification head is a key in the character recognition model. In the embodiment of the present application, in order to reduce a computing pressure of the edge device, the parameter update is performed on the classification head in the character recognition model when the character recognition model deployed on the edge device is trained. In this case, this state equation indicates the evolutionary relationship of the classification head parameter in the character recognition model between different time steps. The observation equation is used to reflect a change in the classification head parameter.

The parameter update is performed on the classification head in the character recognition model via the state space model, making it sufficient for the edge device to maintain the state equation as well as a number of fixed-size matrices required in the observation equation during model training. Compared with a manner of an iterative update via a gradient descent, it may save time of a model update, and avoid a case of catastrophic forgetting that may occur in model training via a gradient descent method, achieving real-time update training of the character recognition model in the edge device.

In summary, according to the method for training the character recognition model provided by the embodiment of the present application, the edge device, after receiving the input image and the labeled string of the input image, calls the character recognition model pre-deployed on the edge device to perform the character recognition on the input image to obtain the corresponding predicted string. The parameter update is performed on the classification head in the character recognition model via the state space model in the case where the predicted string is inconsistent with the labeled string. The state equation in the state space model is used to indicate an evolutionary relationship of the classification head parameter between different time steps. The observation equation is used to generate the observable observation character based on the classification head parameter. Via the above method, an amount of data that the edge device needs to process during model training may be reduced, and learning and training of the deep OCR model are performed in real time in the edge device, simplifying a model training process, reducing a learning cost, and improving model training efficiency.

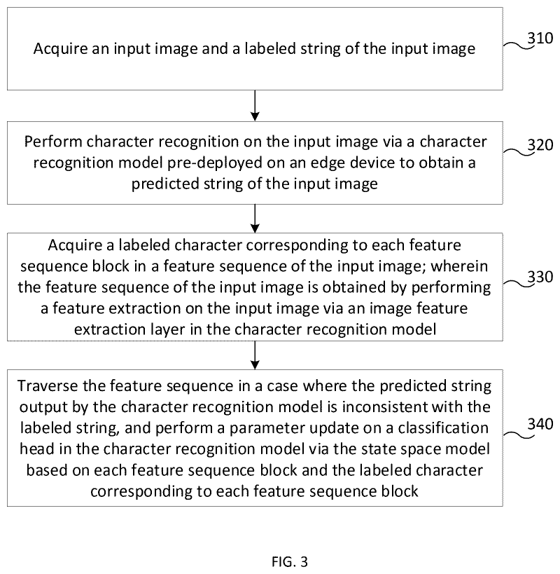

In a case where the predicted string output by the character recognition model is consistent with the labeled string, there is no need to perform update training on the character recognition model. In a case where the predicted string output by the character recognition model is consistent with the labeled string, model training is performed based on the method for training the character recognition model provided by the present application. An illustration is provided below using an example that the predicted string is inconsistent with the labeled string. FIG. 3 shows a flowchart of training a character recognition model provided by an exemplary embodiment of the present application. The method may be performed by an edge device. The edge device may be implemented as a server or a terminal. As shown in FIG. 3, the method for training the character recognition model may include the following steps.

Step 310, an input image and a labeled string of the input image are acquired.

Step 320, character recognition is performed on the input image via the character recognition model pre-deployed on the edge device to obtain a predicted string of the input image.

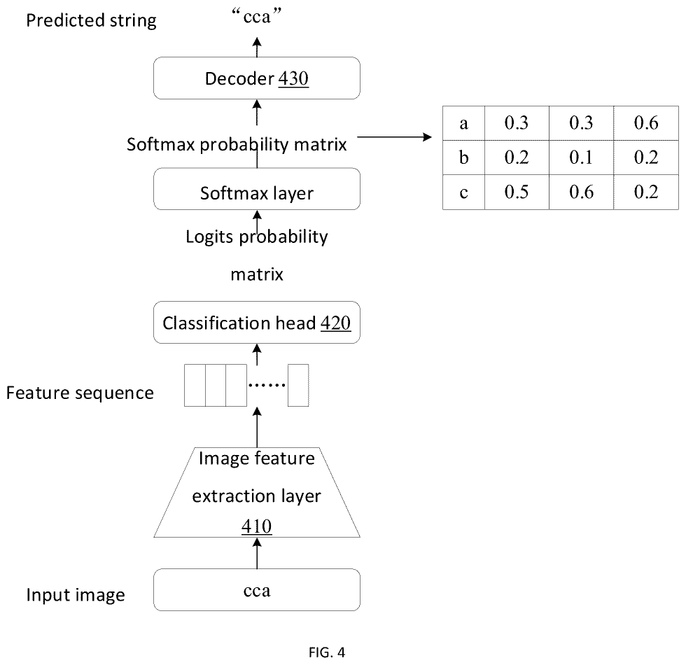

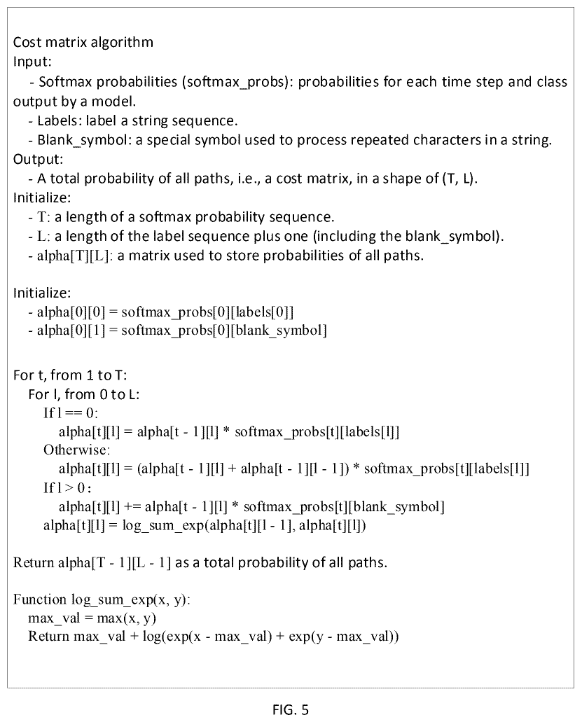

The character recognition model pre-deployed on the edge device is a deep OCR model. FIG. 4 shows a schematic structural diagram of a character recognition model provided by an exemplary embodiment of the present application. As shown in FIG. 4, the character recognition model 400 contains an image feature extraction layer 410, a classification head 420, and a decoder 430.

The image feature extraction layer 410 may extract idiosyncratic features using a convolutional neural network to obtain a feature sequence of the input image, and input the feature sequence to the classification head 420. The feature sequence may be represented as a group of high-dimensional dense vectors in a shape of (length of sequence, dimension of feature) represented as (T, F), where T represents a length of the feature sequence, and F represents a dimension of a feature vector. A value of T is related to a width of the input image and fixed scaling of the image feature extraction layer. T is approximately equal to the width of the image * the scaling of the image feature extraction layer.

This classification head 420 is configured to classify each feature vector in the feature sequence, i.e., judge each position that may represent a character, obtain a probability distribution of converting a corresponding feature vector into a text character, and output a vector in a shape of (C), where C represents the number of classes of a character set, i.e., the number of character classes that may be predicted by the model, e.g., English letter, numeral, special symbol, and other character classes. Schematically, in a case of an English character set, C may be 128 (for an ASCII character set) or larger (taking into account capital and lower-case letters, numeral, and other symbols).

The classification head 420, after performing character recognition on each feature vector in the feature sequence, may obtain a logits probability matrix in a shape (T, C), where the Logits probability matrix contains unnormalized scores, and each element represents an original probability score that the model considers that the feature sequence belongs to a certain specific character class at a certain time step. This classification head 420 may be followed by a softmax layer. This Softmax layer converts the logits probability matrix into a softmax probability matrix applying a softmax method. Its shape is still (T, C). A role of the softmax function is to convert a logits score of each feature vector into a probability distribution. As shown in FIG. 4, each column of this matrix sums (i.e., a sum of probabilities of all character classes at the same time step) equal to 1. An element of each output vector in the softmax probability matrix represents a probability that the model predicts that a current feature belongs to the individual character class.

The decoder 430 is configured to decode the softmax probability matrix into an actual string. Optionally, the decoder may output a character at a position corresponding to a maximum value in each column of the softmax probability matrix as a predicted character, ultimately convert feature vectors in the feature sequence into readable text, and output the predicted string.

Assuming that the number of classes of the character set supported by the character recognition model is C, after an input image and a corresponding labeled string are input into the edge device, the edge device inputs the input image into a feature extraction model of the pre-trained OCR model and performs a feature extraction to obtain the feature sequence containing a plurality of feature sequence blocks. The feature sequence blocks are a series of high-dimensional dense vectors with a dimension F, represented by X, in a shape of (T, F). The feature sequence is input into the classification head of the pre-trained OCR model. A parameter of the classification head is represented by W, in a shape of (F, C). An output of the classification head is represented by a matrix Y_logits, in a shape of (T, C), which represents a logarithmic probability that T feature sequence blocks belong to each of C characters. Then a softmax transformation is applied to the Y_logits to obtain Y, which is converted to a softmax probability matrix. The softmax probability matrix is input to the decoder for decoding, and the predicted string of the input image is obtained.

Step 330, a labeled character corresponding to each feature sequence block in a feature sequence of the input image is acquired. The feature sequence of the input image is obtained by performing a feature extraction on the input image via an image feature extraction layer in the character recognition model.

In a possible implementation, the labeled character corresponding to each feature sequence block is labeled manually.

In another possible implementation, the labeled character corresponding to each feature sequence block is obtained after a computer device performs labeling matching via an adaptive labeling matching method. This process may be implemented as follows.

A logits probability matrix corresponding to the feature sequence is acquired. The logits probability matrix is obtained by performing feature classification on the feature sequence via the classification head of the character recognition model. The logits probability matrix contains a probability distribution of converting each feature sequence block in the feature sequence into a character.

A cost matrix is calculated based on the labeled string and the logits probability matrix. The cost matrix is used to indicate a cost of assigning each character in the labeled string to each image feature in the feature sequence.

Assignment paths are traversed based on the cost matrix, and a target assignment path is determined. The target assignment path is an assignment path with a minimum overall cost.

The labeled character corresponding to each feature sequence block in the feature sequence of the input image is determined based on a path vector corresponding to the target assignment path. The path vector is used to indicate a feature sequence block assigned to each character in the labeled string.

Schematically, if the labeled string contains L characters and the probability matrix is Y, the edge device may calculate the cost matrix (T, L) via a cost matrix algorithm based on the labeled string and the logits probability matrix, representing a cost of assigning each character in the labeled string to each image feature block. FIG. 5 shows a calculation flow of a cost matrix algorithm provided by an exemplary embodiment of the present application. As shown in FIG. 5, in the process of calculating the cost matrix, inputs are the softmax probability matrix (i.e., the logits probability matrix), the labeled string, and a blank_symbol, where the blank_symbol is a special symbol used to process repeated characters in the string. An output is a total probability of all the paths, i.e., the cost matrix, in a shape of (T, L). Before the traversal of the assignment paths begins, matrix initial values are set to ensure that influences of an initial state and the blank_symbol are taken into account. alpha[0] [0] is initialized to a probability that a first time step corresponds to a first non-blank character. alpha [0] [1] is initialized to a probability that the first time step corresponds to the blank_symbol. In the embodiment of the present application, one time step corresponds to one feature sequence block. When the cost matrix is dynamically planned to be filled, the cost matrix is gradually filled by traversing each time step t (from 1 to T) and each possible path length 1 (from 0 to L) via a two-layer loop.

A boundary condition is that when 1==0, implying that a path that does not contain an output of the current time step is considered, at this time a path probability is equal to a probability of the same column (i.e., the same path length) at a previous time step multiplied by a probability that the current time step corresponds to the first character.

A non-boundary condition is that for 1>0, a per-step probability accumulation comes from two sources: a path probability of the same character at the previous time step continues to the current time step; or, a path probability of the same length-minus-one at the previous time step (considering the addition of the blank_symbol) continues to the current time step, and the current character is selected.

In addition to the direct continuation of the path, it is also necessary to additionally accumulate a probability of adding the blank_symbol at the current character to maintain the flexibility of the traversal of the assignment paths. The use of the log_sum_exp function to accumulate and normalize the probability may avoid an underflow problem and simplify a subsequent calculation. Ultimately, alpha [T-1][L-1] contains a cumulative log probability of all possible paths, from the beginning to the end of the sequence.

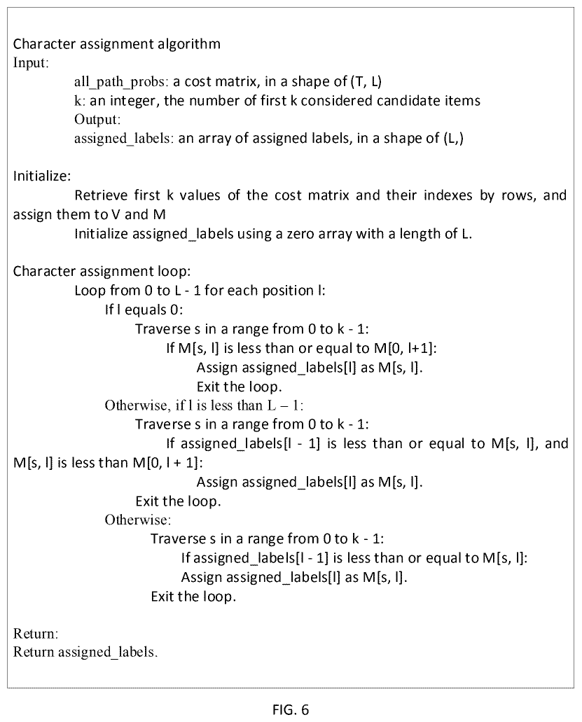

After the cost matrix is acquired, the edge device may determine a target assignment path based on this cost matrix via a character assignment algorithm so as to minimize an overall cost. The path is represented by a vector in a shape of (L). Each numeral in the vector represents to which feature sequence block the character at the current position is assigned. FIG. 6 shows a calculation flow of a character assignment algorithm provided by an exemplary embodiment of the present application. As shown in FIG. 6, when character assignment is performed, inputs are a cost matrix and a number k of candidate items. The number of candidate items is used to indicate the number of candidates for an optimal path considered at each point in time, so as to limit a search range and reduce calculation complexity. A numerical value of the number of candidate items may be set based on actual needs, which is not limited by the present application. An output is a one-dimensional datum, representing a most probable character sequence assigned to the feature sequence, with a same length as the feature sequence. In this flow of the algorithm, initialization is performed first. First k values with a highest probability and their corresponding indexes (denoted as V and M) are found out from each row of the cost matrix. This step is implemented either by sorting or by direct selection. Then, an array assigned_labels with a length of L is initialized to store a final character assignment result. In the character assignment loop, for each position 1 (from 0 to L-1) in the sequence, first k candidate values are traversed during processing at a start position (1==0) to find character assignment with a lowest cost, while ensuring that the cost of this character does not exceed a cost of a first candidate character at a next position, so as to ensure the coherence of the sequence. Once an eligible character is found, it is assigned to assigned_labels [1]. During processing at a middle position (0<1<L-1), in addition to meeting a basic cost condition, it is also necessary to check whether the current character and a character at a previous position form a valid sequence (i.e., considering the continuity of the characters). Specifically, only if a new character has a cost lower than an optimal cost at a next point in time and is continuous with the character at the previous position, it is assigned to the current position. During processing at an end position (1==L-1), it is the end of the sequence, there is no longer any need to consider coherence with the next position, so character assignment with the lowest cost may be found directly. After the loop ends, the assigned_labels array contains optimal character assignment for each position of the input sequence, thus obtaining the target assignment path.

Optionally, a process of determining the labeled character corresponding to each feature block in the feature sequence of the input image based on the path vector corresponding to the target assignment path may be implemented as follows. Labeled characters corresponding to a part of feature sequence blocks in the feature sequence of the input image are determined based on the path vector. Labeled characters corresponding to another part of the feature sequence blocks in the feature sequence of the input image are set as null characters.

That is to say, after each character in the labeled string is assigned to a corresponding feature sequence block in the feature sequence based on the target assignment path, if a feature sequence block to which no character is assigned still exists in the feature sequence, a corresponding character of this feature sequence block is set as a null character.

Step 340, the feature sequence is traversed in a case where the predicted string output by the character recognition model is inconsistent with the labeled string, and the parameter update is performed on the classification head in the character recognition model via the state space model based on each feature sequence block and the labeled character corresponding to each feature sequence block.

In the embodiment of the present application, in determining whether the predicted string output by the character recognition model is consistent with the labeled string, the edge device determines that the predicted string is inconsistent with the labeled string when the feature sequence of the input image contains a target feature sequence block set. A predicted character of each feature sequence block in the target feature sequence block set is inconsistent with a corresponding labeled character.

That is to say, in a case where there is a corresponding predicted character in the target feature sequence block that is inconsistent with the labeled character, it is determined that the predicted string output by the character recognition model is inconsistent with the labeled string. When predicted characters corresponding to all of the feature sequence blocks in the target feature sequence are consistent with corresponding labeled characters, it is determined that the predicted string is consistent with the labeled string.

In the case where it is determined that the predicted string output by the character recognition model is inconsistent with the labeled string, the edge device performs the parameter update on the classification head in the character recognition model via the state space model based on the target feature sequence block set. That is to say, in order to further reduce the amount of data that the edge device needs to process, when a model update is performed on the character recognition model, a feature sequence block whose predicted character is inconsistent with the labeled character, as well as a corresponding labeled character, are selected from a dimension of the feature sequence block as model training data for the model parameter update, so as to reduce the amount of unnecessary calculation.

The process of performing the parameter update on the classification head in the character recognition model via the state space model may be implemented as follows.

A classification head parameter at a (k+1)-th time step is predicted based on a classification head parameter at a k-th time step corresponding to a target feature sequence block as well as the state equation to obtain a predicted classification head parameter at the (k+1)-th time step. The target feature sequence block is any feature sequence block in the feature sequence, and k is a positive integer.

A matrix update is performed on an error covariance matrix at the k-th time step based on a matrix update rule, and an error covariance matrix at the (k+1)-th time step is obtained.

A parameter update is performed on the classification head parameters and the error covariance matrices based on an observation character corresponding to the target feature sequence block, a labeled character corresponding to the target feature sequence block, the predicted classification head parameter at the (k+1)-th time step, and a Kalman gain. The observation character corresponding to the target feature sequence block is obtained by a calculation of the observation equation based on the target feature sequence block as well as the classification head parameter at the k-th time step. The Kalman gain is obtained by a calculation based on the error covariance matrix at the k-th time step and the error covariance matrix at the (k+1)-th time step.

Schematically, corresponding to the representation of the state space model in the embodiment shown in FIG. 1, in the embodiment of the present application, a to-be-updated parameter is a classification head parameter W in the character recognition model, so xₖ in the state space model is replaced with wₖ, representing a classification head parameter W at a moment k. An observation matrix Hₖ in the observation equation is replaced with qₖ, representing a feature sequence block Q at the moment k. Therefore, the following state space model is obtained.

State equation:

$${w}_{k + 1} = {Aw}_{A} + Bu$$

where u is an all-1 vector in a shape of (1, F).

Observation equation:

$${y}_{k} = {q}_{k} {w}_{k} + {v}_{k}$$

Without considering an observation noise, this observation equation may also be expressed as:

$${y}_{k} = {q}_{{k}^{W} k}$$

In the process of the parameter update, parameters A and B are first initialized. A shape of A is (F, F). A shape of B is (F). It is desired that the model parameter update affects an existing model recognition effect as little as possible, thus a state transfer of the classification head parameter W does not to damage existing knowledge, i.e., the classification head parameter W needs to retain a sufficient memory in the past, therefore, certain constraints are imposed on the state transfer matrices A and B in the embodiment of the present application. A and B that meet the constraints need to meet the following formulas:

$${A}_{nk} = \{ \begin{matrix}{( 2 n + 1 )}^{\frac{1}{2}} {( 2 k + 1 )}^{\frac{1}{2}} & if n > k \\ n + 1 & if n = k \\ 0 & if n < k\end{matrix} \\ {B}_{n} = {( 2 n + 1 )}^{\frac{1}{2}}$$

where n and k represent an n-th row and a k-th column respectively. Such A and B may be called HiPPO matrices.

An error covariance matrix P is initialized. This covariance matrix is a unit-diagonal matrix in a shape of (F, F), i.e., all elements are 0 except for those on a diagonal which are 1.

Afterwards, a recursive update of parameters is performed, and when a new feature sequence block qₖ and a corresponding labeled character yₖ arrive:

firstly, w_{k+1|k} is predicted according to the state equation, and an error covariance matrix P_{k+1|k} is updated at the same time:

$${w}_{k + 1 \vert k} = {Aw}_{k} + Bu \\ {P}_{k + 1 \vert k} = {AP}_{k} {A}^{T}$$

{k+1|k} represents a prediction made for a value of k+1 in a next step using a value of k in a previous step.

Then wₖ and Pₖ are updated using an observation equation:

$$K = {P}_{k + 1 \vert k} {{q}_{k}^{T} ( {q}_{k} {P}_{k + 1 \vert k} {q}_{k}^{T} + I )}^{- 1}$$

If there are n new feature sequence blocks qₖ and corresponding labeled characters yₖ, the above process of recursive update of parameters is repeated to update a set of classification head parameters W of the classification head in the character recognition model.

In the above process of updating the model parameters, the edge device only needs to maintain the fixed-size A, B, and P, as well as the u matrix, which does not occupy too much memory with the increase of sample data. At the same time, in the update of the classification head parameters, it only needs to perform several matrix multiplication operations, thus reducing the training complexity, so as to complete update training of the character recognition model with a very low delay.

In summary, according to the method for training the character recognition model provided by the embodiment of the present application, the edge device, after receiving the input image and the labeled string of the input image, calls the character recognition model pre-deployed on the edge device to perform the character recognition on the input image. The corresponding predicted string is obtained. The parameter update is performed on the classification head in the character recognition model via the state space model in the case where the predicted string is inconsistent with the labeled string. The state equation in the state space model is used to indicate an evolutionary relationship of the classification head parameter between different time steps. The observation equation is used to generate the observable observation character based on the classification head parameter. Via the above method, learning and training of the deep OCR model are performed in real time in the edge device, simplifying a model training process, reducing a learning cost, and improving model training efficiency.

In addition, when the labeled character corresponding to each feature sequence block in the feature sequence corresponding to the input image is determined, automatic matching of labeling is performed in an adaptive labeling matching manner, which may reduce an error caused by manual labeling as well as reduce a cost, improving the accuracy of character labeling, thus improving the accuracy of the model parameter update.

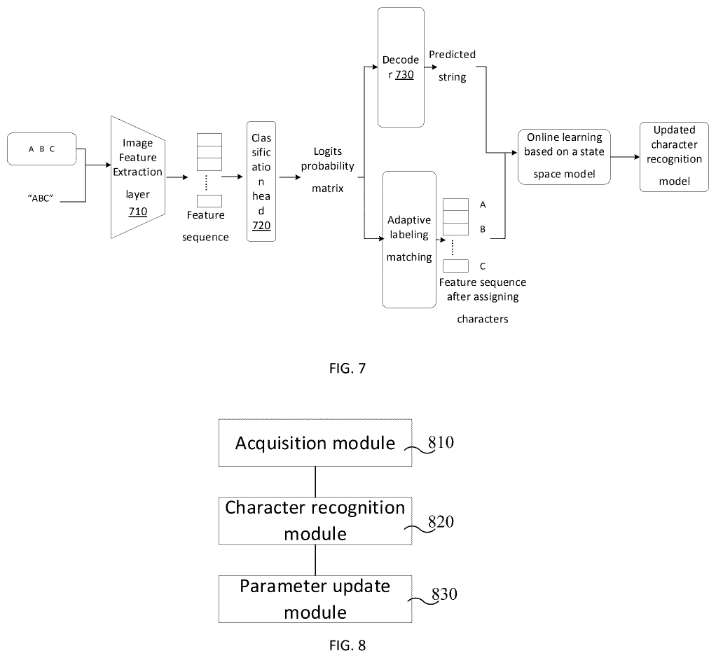

FIG. 7 shows a block flowchart of a method for training a character recognition model provided by an exemplary embodiment of the present application. As shown in FIG. 7, after an edge device receives an input image and a labeled string of the input image, the input image is input into an image feature extraction layer 710 of the character recognition model for a feature extraction to obtain a feature sequence. The feature sequence is input into a classification head 720 to obtain a logits probability matrix. Afterwards, on the one hand, the logits probability matrix is input into a decoder 730 to obtain a predicted string output by the decoder 730. On the other hand, adaptive labeling matching is performed based on the logits probability matrix and the labeled string to obtain a labeled character corresponding to each feature character block in the feature sequence. Finally, in a case where the predicted string is inconsistent with the labeled string, a parameter update is performed on the classification head parameter in the character recognition module based on the feature sequence block in the feature sequence whose corresponding predicted character does not match with the labeled character, and based on the state space model, and the updated character recognition model is obtained.

FIG. 8 shows a block diagram of an apparatus for training a character recognition model provided by an exemplary embodiment of the present application. The apparatus may be applied in an edge device to perform all or some of the steps of the embodiments shown in FIG. 1 or FIG. 3. As shown in FIG. 8, the apparatus for training the character recognition model includes:
an acquisition module 810, configured to acquire an input image and a labeled string of the input image;
a character recognition module 820, configured to perform character recognition on the input image via the character recognition model pre-deployed on the edge device to obtain a predicted string of the input image; and
a parameter update module 820, configured to perform a parameter update on a classification head in the character recognition model via a state space model in a case where the predicted string is inconsistent with the labeled string. The state space model contains a state equation and an observation equation. The state equation is used to indicate an evolutionary relationship of a classification head parameter between different time steps. The observation equation is used to generate an observable observation character based on the classification head parameter.

In a possible implementation, the parameter update module 830 includes:
a labeled character acquisition sub-module, configured to acquire a labeled character corresponding to each feature sequence block in a feature sequence of the input image; wherein the feature sequence of the input image is obtained by performing a feature extraction on the input image via an image feature extraction layer in the character recognition model; and
a parameter update sub-module, configured to traverse the feature sequence, and perform, based on each feature sequence block and the labeled character corresponding to each feature sequence block, the parameter update on the classification head in the character recognition model via the state space model.

In a possible implementation, the parameter update sub-module is configured to
predict a classification head parameter at a (k+1)-th time step based on a classification head parameter at a k-th time step corresponding to a target feature sequence block as well as the state equation to obtain a predicted classification head parameter at the (k+1)-th time step, wherein the target feature sequence block is any feature sequence block in the feature sequence, and k is a positive integer;
perform a matrix update on an error covariance matrix at the k-th time step based on a matrix update rule to obtain an error covariance matrix at the (k+1)-th time step; and
perform a parameter update on the classification head parameters and the error covariance matrices based on an observation character corresponding to the target feature sequence block, a labeled character corresponding to the target feature sequence block, the predicted classification head parameter at the (k+1)-th time step, and a Kalman gain, wherein the observation character corresponding to the target feature sequence block is obtained by a calculation of the observation equation based on the target feature sequence block as well as the classification head parameter at the k-th time step; and the Kalman gain is obtained by a calculation based on the error covariance matrix at the k-th time step and the error covariance matrix at the (k+1)-th time step.

In a possible implementation, the labeled character acquisition sub-module includes:
a matrix acquisition unit, configured to acquire a logits probability matrix corresponding to the feature sequence; wherein the logits probability matrix is obtained by performing feature classification on the feature sequence via the classification head of the character recognition model, and the logits probability matrix contains a probability distribution of converting each feature sequence block in the feature sequence into a character;
a matrix calculation unit, configured to calculate a cost matrix based on the labeled string and the logits probability matrix, wherein the cost matrix is used to indicate a cost of assigning each character in the labeled string to each image feature in the feature sequence;
a path determination unit, configured to traverse assignment paths based on the cost matrix, and determine a target assignment path, wherein the target assignment path is an assignment path with a minimum overall cost; and
a labeled character determination unit, configured to determine the labeled character corresponding to each feature sequence block in the feature sequence of the input image based on a path vector corresponding to the target assignment path, wherein the path vector is used to indicate a feature sequence block assigned to each character in the labeled string.

In a possible implementation, the labeled character determination unit is configured to
determine labeled characters corresponding to a part of feature sequence blocks in the feature sequence of the input image based on the path vector; and
set labeled characters corresponding to another part of the feature sequence blocks in the feature sequence of the input image as null characters.

In a possible implementation, the apparatus further includes:
a match module, configured to determine that the predicted string is inconsistent with the labeled string when the feature sequence of the input image contains a target feature sequence block set; wherein a predicted character of each feature sequence block in the target feature sequence block set is inconsistent with a corresponding labeled character.

In a possible implementation, the parameter update module 830 is configured to perform, based on the target feature sequence block set, the parameter update on the classification head in the character recognition model via the state space model.

In summary, the apparatus for training the character recognition model provided by the embodiment of the present application is applied in the edge device, so that the edge device, after receiving the input image and the labeled string of the input image, calls the character recognition model pre-deployed on the edge device to perform the character recognition on the input image. The corresponding predicted string is obtained. The parameter update is performed on the classification head in the character recognition model via the state space model in the case where the predicted string is inconsistent with the labeled string. The state equation in the state space model is used to indicate an evolutionary relationship of the classification head parameter between different time steps. The observation equation is used to generate the observable observation character based on the classification head parameter. Via the above apparatus, an amount of data that the edge device needs to process during model training may be reduced, and learning and training of the deep OCR model are performed in real time in the edge device, simplifying a model training process, reducing a learning cost, and improving model training efficiency.

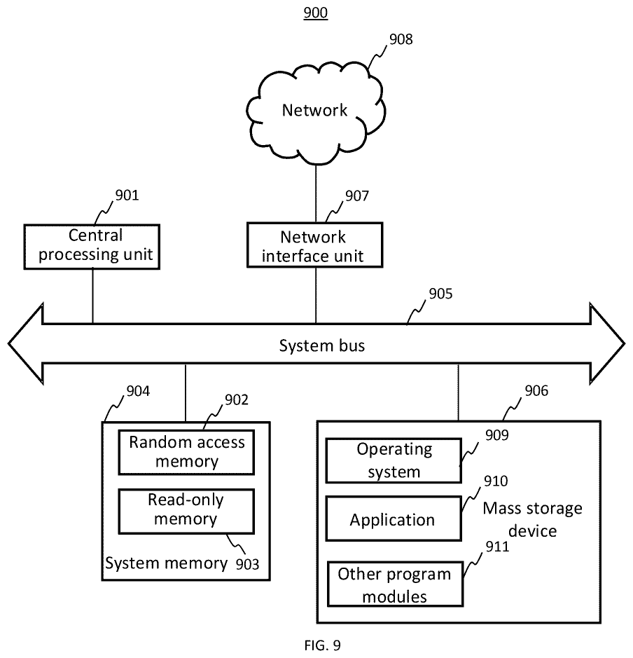

FIG. 9 shows a structural block diagram of a computer device 900 showed by an exemplary embodiment of the present application. The computer device may be implemented as a server in the above solution of the present application. The computer device 900 includes a central processing unit (CPU) 901, a system memory 904 including a random access memory (RAM) 902 and a read-only memory (ROM) 903, and a system bus 905 connecting the system memory 904 and the central processing unit 901. The computer device 900 further includes a mass storage device 906 for storing an operating system 909, an application 910 and other program modules 911.

Without loss of generality, a computer-readable medium may include a computer storage medium and a communication medium. The computer storage medium includes volatile and non-volatile, removable and non-removable media implemented in any method or technology for storing information, such as a computer-readable instruction, data structure, program module, or other data. The computer storage medium includes a RAM, a ROM, an erasable programmable read only memory (EPROM), an electrically-erasable programmable read-only memory (EEPROM) flash memory, or other solid-state storage technologies, a CD-ROM, a digital versatile disc (DVD), or other optical storage, a tape cartridge, a tape, disk storage, or other magnetic storage devices. Of course, those skilled in the art may know that the computer storage medium is not limited to the above ones. The system memory 904 and mass storage device 906 above may be collectively referred to as a memory.

According to various embodiments of the present disclosure, the computer device 900 may also be connected to a remote computer on a network for operation via a network such as the Internet. That is, the computer device 900 may be connected to the network 908 via a network interface unit 907 connected to the system bus 905, or, the computer device 900 may also be connected to other types of networks or remote computer systems (not shown) using the network interface unit 907.

The memory further includes at least one instruction, at least one segment of program, a code set, or an instruction set. The at least one instruction, the at least one segment of program, the code set, or the instruction set are stored in the memory. The central processing unit 901 implements all or some of the steps in the method for training the character recognition model shown in the various embodiments above by executing the at least one instruction, the at least one segment of program, the code set, or the instruction set.

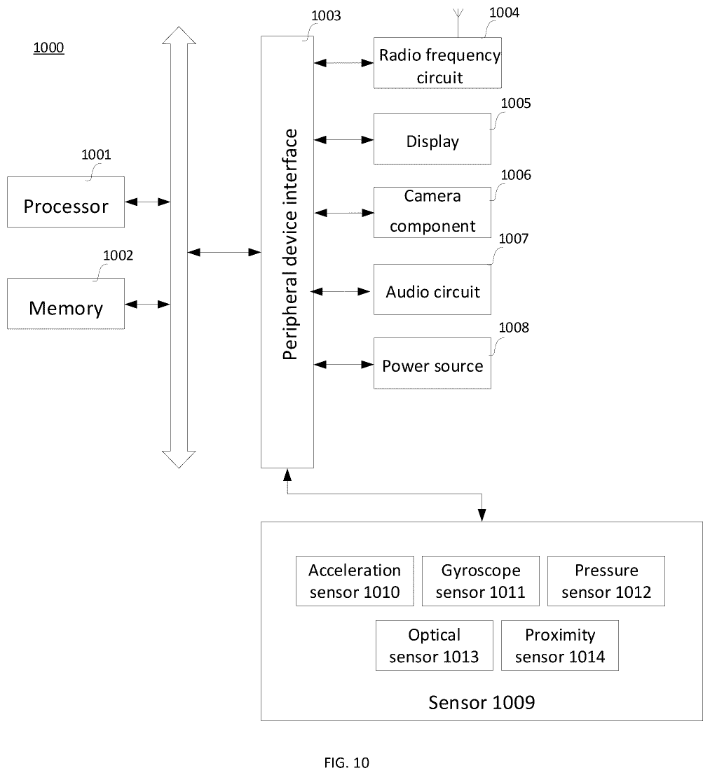

FIG. 10 shows a structural block diagram of a computer device 1000 showed by an exemplary embodiment of the present application. The computer device 1000 may be implemented as a terminal above, for example: a smartphone, a tablet, a laptop, and a desktop computer. The computer device 1000 may also be referred to as a user device, a portable terminal, a laptop terminal, a desktop terminal, and other names.

Typically, the computer device 1000 includes: a processor 1001 and a memory 1002.

In some embodiments, the computer device 1000 also optionally includes: a peripheral device interface 1003 and at least one peripheral device. The processor 1001, the memory 1002, and the peripheral device interface 1003 may be connected via a bus or a signal line. Each peripheral device may be connected to the peripheral device interface 1003 via a bus, a signal line, or a circuit board. Specifically, the peripheral device includes at least one of a radio frequency circuit 1004, a display 1005, a camera assembly 1006, an audio circuit 1007, and a power source 1008.

In some embodiments, the computer device 1000 further includes one or more sensors 1009. The one or more sensors 1009 include, but are not limited to: an acceleration sensor 1010, a gyroscope sensor 1011, a pressure sensor 1012, an optical sensor 1013, and a proximity sensor 1014.

Those skilled in the art may understand that the structure illustrated in FIG. 10 does not constitute a limitation of the computer device 1000, and may include more or fewer components than illustrated, or combine certain components, or adopt a different component arrangement.

In an exemplary embodiment, a computer-readable storage medium is further provided, storing at least one computer program therein. The computer program is loaded and executed by a processor to implement all or some of the steps of the above method for training the character recognition model. For example, the computer-readable storage medium may be a read-only memory (ROM), a random-access memory (RAM), a compact disc read-only memory (CD-ROM), a tape, a floppy disk, an optical data storage device, etc.

In an exemplary embodiment, a computer program product is further provided, including a computer program stored on a non-transitory computer-readable storage medium. The computer program includes program instructions. The program instructions, when executed by a computer, cause the computer to implement all or some of the steps of the method for training the character recognition model shown in FIG. 1 or FIG. 3 above.

Those skilled in the art will easily think of other solutions of the present application after the consideration of the specification and practice of the application disclosed here. The present application is intended to cover any variation, use, or adaptation of the present application that follows the general principles of the present application and includes common knowledge or customary technical means in the technical field that are not disclosed in the present application. The specification and embodiments are considered exemplary merely, and the true scope and spirit of the present application are indicated by the following claims.

It should be understood that the present application is not limited to the exact construction that has been described above and illustrated in the accompanying drawings, and that various modifications and changes may be made without departing from its scope. The scope of the present application is merely limited by the appended claims.

The invention claimed is:

1. A method for training a character recognition model, performed by an edge device, comprising:
acquiring an input image and a labeled string of the input image;
performing character recognition on the input image via the character recognition model pre-deployed on the edge device to obtain a predicted string of the input image; and
performing a parameter update on a classification head in the character recognition model via a state space model in a case where the predicted string is inconsistent with the labeled string;
wherein the state space model contains a state equation and an observation equation, the state equation is used to indicate an evolutionary relationship of a classification head parameter between different time steps, and the observation equation is used to generate an observable observation character based on the classification head parameter.

2. The method according to claim 1, wherein performing the parameter update on the classification head in the character recognition model via the state space model comprises:
acquiring a labeled character corresponding to each feature sequence block in a feature sequence of the input image; wherein the feature sequence of the input image is obtained by performing a feature extraction on the input image via an image feature extraction layer in the character recognition model; and
traversing the feature sequence, and performing, based on each feature sequence block and the labeled character corresponding to each feature sequence block, the parameter update on the classification head in the character recognition model via the state space model.

3. The method according to claim 2, wherein performing, based on each feature sequence block and the labeled character corresponding to each feature sequence block, the parameter update on the classification head in the character recognition model via the state space model comprises:
predicting a classification head parameter at a (k+1)-th time step based on a classification head parameter at a k-th time step corresponding to a target feature sequence block as well as the state equation to obtain a predicted classification head parameter at the (k+1)-th time step, wherein the target feature sequence block is any feature sequence block in the feature sequence, and k is a positive integer;
performing a matrix update on an error covariance matrix at the k-th time step based on a matrix update rule to obtain an error covariance matrix at the (k+1)-th time step; and
performing a parameter update on the classification head parameters and error covariance matrices based on an observation character corresponding to the target feature sequence block, a labeled character corresponding to the target feature sequence block, the predicted classification head parameter at the (k+1)-th time step, and a Kalman gain, wherein the observation character corresponding to the target feature sequence block is obtained by a calculation of the observation equation based on the target feature sequence block as well as the classification head parameter at the k-th time step; and the Kalman gain is obtained by a calculation based on the error covariance matrix at the k-th time step and the error covariance matrix at the (k+1)-th time step.

4. The method according to claim 2, wherein acquiring the labeled character corresponding to each feature sequence block in the feature sequence of the input image comprises:
acquiring a logits probability matrix corresponding to the feature sequence; wherein the logits probability matrix is obtained by performing feature classification on the feature sequence via the classification head of the character recognition model, and the logits probability matrix contains a probability distribution of converting each feature sequence block in the feature sequence into a character;
calculating a cost matrix based on the labeled string and the logits probability matrix, wherein the cost matrix is used to indicate a cost of assigning each character in the labeled string to each image feature in the feature sequence;
traversing assignment paths based on the cost matrix, and determining a target assignment path, wherein the target assignment path is an assignment path with a minimum overall cost; and
determining the labeled character corresponding to each feature sequence block in the feature sequence of the input image based on a path vector corresponding to the target assignment path, wherein the path vector is used to indicate a feature sequence block assigned to each character in the labeled string.

5. The method according to claim 4, wherein determining the labeled character corresponding to each feature sequence block in the feature sequence of the input image based on the path vector corresponding to the target assignment path comprises:
determining labeled characters corresponding to a part of feature sequence blocks in the feature sequence of the input image based on the path vector; and
setting labeled characters corresponding to another part of the feature sequence blocks in the feature sequence of the input image as null characters.

6. The method according to claim 4, further comprising:
determining that the predicted string is inconsistent with the labeled string when the feature sequence of the input image contains a target feature sequence block set; wherein a predicted character of each feature sequence block in the target feature sequence block set is inconsistent with a corresponding labeled character.

7. The method according to claim 6, wherein performing the parameter update on the classification head in the character recognition model via the state space model in the case where the predicted string is inconsistent with the labeled string comprises:
performing, based on the target feature sequence block set, the parameter update on the classification head in the character recognition model via the state space model.

8. An apparatus for training a character recognition model, applied in an edge device, comprising:
an acquisition module, configured to acquire an input image and a labeled string of the input image;
a character recognition module, configured to perform character recognition on the input image via the character recognition model pre-deployed on the edge device to obtain a predicted string of the input image; and
a parameter update module, configured to perform a parameter update on a classification head in the character recognition model via a state space model in a case where the predicted string is inconsistent with the labeled string; wherein the state space model contains a state equation and an observation equation, the state equation is used to indicate an evolutionary relationship of a classification head parameter between different time steps, and the observation equation is used to generate an observable observation character based on the classification head parameter.

9. A computer device, comprising a processor and a memory, wherein the memory stores at least one computer program, and the at least one computer program is loaded and executed by the processor to:
acquire an input image and a labeled string of the input image;
perform character recognition on the input image via the character recognition model pre-deployed on an edge device to obtain a predicted string of the input image; and
perform a parameter update on a classification head in the character recognition model via a state space model in a case where the predicted string is inconsistent with the labeled string;
wherein the state space model contains a state equation and an observation equation, the state equation is used to indicate an evolutionary relationship of a classification head parameter between different time steps, and the observation equation is used to generate an observable observation character based on the classification head parameter.

10. The computer device according to claim 9, wherein perform the parameter update on the classification head in the character recognition model via the state space model comprises:
acquire a labeled character corresponding to each feature sequence block in a feature sequence of the input image; wherein the feature sequence of the input image is obtained by performing a feature extraction on the input image via an image feature extraction layer in the character recognition model; and
traverse the feature sequence, and performing, based on each feature sequence block and the labeled character corresponding to each feature sequence block, the parameter update on the classification head in the character recognition model via the state space model.

11. The computer device according to claim 10 wherein perform, based on each feature sequence block and the labeled character corresponding to each feature sequence block, the parameter update on the classification head in the character recognition model via the state space model comprises:
predict a classification head parameter at a (k+1)-th time step based on a classification head parameter at a k-th time step corresponding to a target feature sequence block as well as the state equation to obtain a predicted classification head parameter at the (k+1)-th time step, wherein the target feature sequence block is any feature sequence block in the feature sequence, and k is a positive integer;
perform a matrix update on an error covariance matrix at the k-th time step based on a matrix update rule to obtain an error covariance matrix at the (k+1)-th time step; and
perform a parameter update on the classification head parameters and error covariance matrices based on an observation character corresponding to the target feature sequence block, a labeled character corresponding to the target feature sequence block, the predicted classification head parameter at the (k+1)-th time step, and a Kalman gain, wherein the observation character corresponding to the target feature sequence block is obtained by a calculation of the observation equation based on the target feature sequence block as well as the classification head parameter at the k-th time step; and the Kalman gain is obtained by a calculation based on the error covariance matrix at the k-th time step and the error covariance matrix at the (k+1)-th time step.

12. The computer device according to claim 10, wherein acquire the labeled character corresponding to each feature sequence block in the feature sequence of the input image comprises:
acquire a logits probability matrix corresponding to the feature sequence; wherein the logits probability matrix is obtained by performing feature classification on the feature sequence via the classification head of the character recognition model, and the logits probability matrix contains a probability distribution of converting each feature sequence block in the feature sequence into a character;
calculate a cost matrix based on the labeled string and the logits probability matrix, wherein the cost matrix is used to indicate a cost of assigning each character in the labeled string to each image feature in the feature sequence;
traverse assignment paths based on the cost matrix, and determining a target assignment path, wherein the target assignment path is an assignment path with a minimum overall cost; and
determine the labeled character corresponding to each feature sequence block in the feature sequence of the input image based on a path vector corresponding to the target assignment path, wherein the path vector is used to indicate a feature sequence block assigned to each character in the labeled string.

13. The computer device according to claim 12, wherein determine the labeled character corresponding to each feature sequence block in the feature sequence of the input image based on the path vector corresponding to the target assignment path comprises:
determine labeled characters corresponding to a part of feature sequence blocks in the feature sequence of the input image based on the path vector; and
set labeled characters corresponding to another part of the feature sequence blocks in the feature sequence of the input image as null characters.

14. The computer device according to claim 12, further comprising:
determine that the predicted string is inconsistent with the labeled string when the feature sequence of the input image contains a target feature sequence block set; wherein a predicted character of each feature sequence block in the target feature sequence block set is inconsistent with a corresponding labeled character.

15. The computer device according to claim 14, wherein perform the parameter update on the classification head in the character recognition model via the state space model in the case where the predicted string is inconsistent with the labeled string comprises:
perform, based on the target feature sequence block set, the parameter update on the classification head in the character recognition model via the state space model.

16. A computer-readable storage medium, storing at least one computer program therein, wherein when the computer program is loaded causes a processor to implement a method for training a character recognition model, comprising:
acquiring an input image and a labeled string of the input image;
performing character recognition on the input image via the character recognition model pre-deployed on an edge device to obtain a predicted string of the input image; and
performing a parameter update on a classification head in the character recognition model via a state space model in a case where the predicted string is inconsistent with the labeled string;
wherein the state space model contains a state equation and an observation equation, the state equation is used to indicate an evolutionary relationship of a classification head parameter between different time steps, and the observation equation is used to generate an observable observation character based on the classification head parameter.

17. The computer-readable storage medium according to claim 16, wherein performing the parameter update on the classification head in the character recognition model via the state space model comprises:
acquiring a labeled character corresponding to each feature sequence block in a feature sequence of the input image; wherein the feature sequence of the input image is obtained by performing a feature extraction on the input image via an image feature extraction layer in the character recognition model; and
traversing the feature sequence, and performing, based on each feature sequence block and the labeled character corresponding to each feature sequence block, the parameter update on the classification head in the character recognition model via the state space model.

18. The computer-readable storage medium according to claim 17, wherein performing, based on each feature sequence block and the labeled character corresponding to each feature sequence block, the parameter update on the classification head in the character recognition model via the state space model comprises:
predicting a classification head parameter at a (k+1)-th time step based on a classification head parameter at a k-th time step corresponding to a target feature sequence block as well as the state equation to obtain a predicted classification head parameter at the (k+1)-th time step, wherein the target feature sequence block is any feature sequence block in the feature sequence, and k is a positive integer;
performing a matrix update on an error covariance matrix at the k-th time step based on a matrix update rule to obtain an error covariance matrix at the (k+1)-th time step; and
performing a parameter update on the classification head parameters and error covariance matrices based on an observation character corresponding to the target feature sequence block, a labeled character corresponding to the target feature sequence block, the predicted classification head parameter at the (k+1)-th time step, and a Kalman gain, wherein the observation character corresponding to the target feature sequence block is obtained by a calculation of the observation equation based on the target feature sequence block as well as the classification head parameter at the k-th time step; and the Kalman gain is obtained by a calculation based on the error covariance matrix at the k-th time step and the error covariance matrix at the (k+1)-th time step.

19. The computer-readable storage medium according to claim 17, wherein acquiring the labeled character corresponding to each feature sequence block in the feature sequence of the input image comprises:
acquiring a logits probability matrix corresponding to the feature sequence; wherein the logits probability matrix is obtained by performing feature classification on the feature sequence via the classification head of the character recognition model, and the logits probability matrix contains a probability distribution of converting each feature sequence block in the feature sequence into a character;
calculating a cost matrix based on the labeled string and the logits probability matrix, wherein the cost matrix is used to indicate a cost of assigning each character in the labeled string to each image feature in the feature sequence;
traversing assignment paths based on the cost matrix, and determining a target assignment path, wherein the target assignment path is an assignment path with a minimum overall cost; and
determining the labeled character corresponding to each feature sequence block in the feature sequence of the input image based on a path vector corresponding to the target assignment path, wherein the path vector is used to indicate a feature sequence block assigned to each character in the labeled string.

20. The computer-readable storage medium according to claim 19, wherein determining the labeled character corresponding to each feature sequence block in the feature sequence of the input image based on the path vector corresponding to the target assignment path comprises:
determining labeled characters corresponding to a part of feature sequence blocks in the feature sequence of the input image based on the path vector; and
setting labeled characters corresponding to another part of the feature sequence blocks in the feature sequence of the input image as null characters.

21. The computer-readable storage medium according to claim 20, further comprising:
determining that the predicted string is inconsistent with the labeled string when the feature sequence of the input image contains a target feature sequence block set; wherein a predicted character of each feature sequence block in the target feature sequence block set is inconsistent with a corresponding labeled character.

22. The computer-readable storage medium according to claim 21, wherein performing the parameter update on the classification head in the character recognition model via the state space model in the case where the predicted string is inconsistent with the labeled string comprises:
performing, based on the target feature sequence block set, the parameter update on the classification head in the character recognition model via the state space model.
